(19) United States
(12) Patent Application Publication
(10) Pub. No.: US 2004/0022181 A1
(43) Pub. Date: Feb. 5, 2004

(54) Pseudo-bit-loading for enhanced performance with standards-compliant air interface for multi-tone wireless lans

(76) Inventor: John T. Coffey, San Francisco, CA (US)

Correspondence Address: TEXAS INSTRUMENTS INCORPORATED, P O BOX 655474, M/S 3999, DALLAS, TX, 75265

(21) Appl. No.: 10/212,343

(22) Filed: Aug. 5, 2002

(51) Int. Cl. H04J 11/00

(52) U.S. Cl. 370/208; 370/528

(57) ABSTRACT

A method 10 is provided to incorporate bit loading into a proprietary or other nonstandard mode, but with the constraint that all transmitted signals are valid packets that adhere to the standard in the sense that the transmitted signals could all arise in the regular standard. That is, it is desirable to confine the nonstandard nature of the transmission to the mapping of data bits to the transmitted waveform, rather than allow new transmission waveforms.

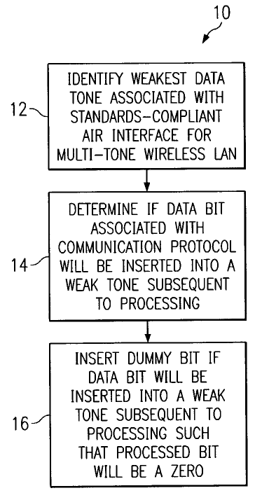

### BACKGROUND OF THE INVENTION

1. Field of the Invention

This invention relates generally to multi-tone data communication systems and methods, and more particularly to applicability of “bit loading” techniques in wireless local area networks (WLANs).

2. Description of the Prior Art

Multi-tone communication systems have been widely adopted in applications such as DSL, broadband wireless access, and wireless local area networks. A frequently quoted motivation for the use of multi-tone systems is their performance in channels that experience frequency-selective fading. A key feature of multi-tone communication as applied in DSL and broadband wireless access systems is “bit loading”, a technique that combats frequency-selective fading effectively. In bit loading, the transmitter uses estimates of the current channel between it and the receiver, and sends less information on severely faded tones than on strong tones. This results in a large performance advantage over a system in which the same amount of information is sent on every tone.

Wireless local area networks standards such as the IEEE 802.11a and HiperLAN 2 standards have incorporated multi-tone PHY layer systems; and these systems are also part of the current incarnation of the IEEE 802.11g draft standard. In these systems, however, no bit loading is incorporated. This has the redeeming advantage that in a channel that changes dynamically from packet to packet, there is no danger of using out-of-date channel information from previous packets in combination with bit loading. This is one justification for the route taken by the standard. Whatever the motivation, however, there is a large performance penalty in the lack of bit loading capability. This affects achievable throughputs, reliability of transmission, and range, which are key desirable attributes of WLAN systems.

Of course it is possible to introduce a proprietary system that uses the general framework of these standards, but adds bit loading, along with suitable channel measurements or feedback from the transmitter to enable it. This, however, creates many potential problems of coexistence with existing standards-compliant networks. In such networks, many devices share the transmission medium, and employ elaborate protocols to ensure coexistence and overall efficient use of the medium. The transmission of signals that are not strictly compliant with the standard, and that therefore will not be recognized by other devices, creates many coexistence problems and presents a significant barrier to acceptance of the mode. In some domains, there may be regulatory barriers to the transmission of such signals.

It is therefore advantageous and desirable to provide a way to incorporate bit loading techniques into a proprietary or other nonstandard mode, but with the constraint that all transmitted signals are valid packets that adhere to the standard in the sense that the transmitted signals could all arise in the regular standard. That is, it is desirable to confine the nonstandard nature of the transmission to the mapping of data bits to the transmitted waveform, rather than allow new transmission waveforms.

### SUMMARY OF THE INVENTION

The present invention is directed to “bit loading” techniques associated with wireless local area networks (WLANs). A method is provided to incorporate bit loading into a proprietary or other nonstandard mode, but with the constraint that all transmitted signals are valid packets that adhere to the standard in the sense that the transmitted signals could all arise in the regular standard. That is, it is desirable to confine the nonstandard nature of the transmission to the mapping of data bits to the transmitted waveform, rather than allow new transmission waveforms.

According to one embodiment, a method of bit loading in a multi-tone wireless local area network (LAN) comprises the steps of identifying the weakest data tone associated with a desired standards-compliant air interface for a multi-tone wireless LAN; determining if any data bit(s) associated with the requisite communication protocol will be inserted into a weak tone subsequent to processing; and inserting a dummy bit if a data bit will be inserted into a weak tone subsequent to processing, such that the processed bit will be a zero.

### BRIEF DESCRIPTION OF THE DRAWINGS

Other aspects and features of the present invention and many of the attendant advantages of the present invention will be readily appreciated as the same become better understood by reference to the following detailed description when considered in connection with the accompanying drawing wherein:

The FIGURE is flowchart depicting a method of pseudo-bit-loading according to one embodiment of the present invention.

While the above-identified drawing FIGURE sets forth a particular embodiment, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

The present invention is best understood with reference first to a main motivating example. This example is formulated in terms of IEEE 802.11a systems, but in almost all respects carries over to similar related systems. In the highest rate, 54 Mbps, mode in IEEE 802.11a systems, the data bits to be transmitted are first fed through a data scrambler, mapping the data sequence to a different data sequence. The scrambled data sequence is then fed through a rate ½ convolutional code. The coded output bits are punctured (a process in which some of the coded bits are thrown away). The punctured coded bits are then fed through an interleaver. The interleaved, punctured coded bits are then grouped into blocks of 6 bits, and mapped to signal points from a 64-QAM constellation, with one 64-QAM constellation per each of 48 data tones. With some final processing, these 48 data tones are assembled into one OFDM “symbol” waveform, and the symbol is transmitted across the channel. An 802.11a packet consists of a header followed by one or more OFDM symbols.

With reference now to the example described herein above, the most elementary version of a pseudo-bit-loading scheme 10 in accordance with one embodiment of the present invention as shown in the FIGURE, works as follows. The transmitter identifies the weakest data tone out of the 48 as shown in block 12. This identification of the weakest data tone may be accomplished either by examining the last packet received from the other party, exploiting the symmetry of the channel seen in either transmission direction, or by the local receiver sending an explicit message indicating which tone it finds as weakest. Note that the number of coded bits sent on this weakest tone equals six times the number of OFDM symbols in the packet. A simple form of bit loading, for illustrative purposes, is to send zero bits of information on this tone, and for other tones to send the normal number of information bits for this mode. Conceptually, this can be achieved by modifying the input data stream in such a way that the eventual (scrambled, coded, punctured and interleaved) stream has six zeros assigned to each 64-QAM symbol mapped to the weakest tone. Considering a bit-by-bit representation of the overall encoding process, in which as data bits arrive one by one, the eventual position and 64-QAM symbol label component corresponding to the output processed bits are immediately calculated. As used herein, a “processed” bit is defined as a bit at the output of the composite scrambling-encoding-puncturing-interleaving operation. Before inserting a data bit into the system where the resulting processed bit or bits will end up, an immediate calculation is then first made to ensure these data bits will not end up in a weak tone that is inserted into the system as shown in block 14. If, however, one of the processed bits ends up on a weak tone, a dummy data bit is then inserted into the system in such a way as to produce a 0 at the output of the processing as shown in block 16. Since the channel code used in the IEEE 802.11a protocol has the property that the two output coded bits each vary with the input bit, it is always possible to choose the input dummy bit so as to set the desired output processed bit to 0. (The case in which there are two output processed bits, each is constrained to a target tone, and they cannot both be set to 0, is discussed herein below.)

The net result of this process is that the input data stream will have been corrupted by the insertion of redundant dummy bits; and the overall rate of the system will have been lowered slightly. On the other hand, there is the desired benefit that the new, corrupted data stream maps to a transmitted waveform that has all zeros on each weak tone, but is also a valid transmitted waveform of the IEEE 802.11a protocol: in fact, it is the valid waveform that would result if the user had happened to want to send the corrupted data, rather than the original data.

At the decoder, the effect of the data corruption can be compensated for in the following way. The special mode is signaled by the use of appropriate header bits, so that the receiver is aware that the transmission has been modified, and is aware of where the modified bits occur. The received waveform, which consists of the transmitted waveform modified by the frequency-selective fading channel, with added noise, is processed in the normal way. However, in the decoder for the convolutional code, all bits corresponding to the weak tones have been constrained to be zero in the transmitted sequence, and so the decoder forces corresponding trellis transitions in the decoding process. This method of allowing for the presence of known bits in decoding a convolutional code is a standard procedure known as “state pinning” and is well understood to those skilled in the art. This method is known to be effective in maintaining high decoder performance. The resulting decoded stream of bits at the output of the normal receiver process is then the receiver's best estimate of the transmitted, corrupted data sequence. The receiver, knowing the weakest tone from its own estimate of the channel, or by agreement with the transmitter, can reverse the dummy bit-stuffing process to identify the dummy bits added to the transmitted stream and recover the original data bits.

Effectively, when all goes well, the system has managed to communicate while avoiding the weakest tone, and still communicating all required information, using a waveform that complies with the air-interface format of the standard.

The present invention is not so limited however, and those skilled in the art will understand the embodiments discussed herein before may be extended in an obvious way to cover more tones, and varying numbers of information bits per tone.

In practice, there are reasons why it is not desirable for the weakest tone always to map to exactly the same bit sequence: this produces undesirable radio effects. To combat this, the transmitter and receiver may agree in advance on a rotating known sequence of fixed bits patterns for the target tones. This produces no essential change to the operation of the proposed scheme.

According to one embodiment of this scheme, the CRC checksum (an overall check to ensure the reliability of the final data) can be modified by masking with a pre-agreed known non-zero pattern. This, being pre-agreed between the transmitter and receiver, will have no adverse effect on reception by the intended recipient. Unintended recipients that conform only to the existing standard, however, will decode the packet in the normal, standards-compliant way, without compensating in the required way for the padded dummy bits. The modification to the overall CRC check will ensure that with very high probability the unintended recipient will produce a CRC error and discard the packet as unreliable. The purpose of this is not security against unauthorized reception, but rather to ensure that the unintended recipient does not utilize information from the decoded MAC header part of the payload to perform any standards-compliant function.

This is important as this information is sometimes used by other devices in the network, and there would otherwise be the danger that these other devices could “decode” a deliberately-corrupted packet and use the corrupted data for network update purposes, with undesirable consequences.

As stated herein before, it is possible that there will be two output processed bits at the next time unit, both to be assigned to restricted tone bits, and that there is no way to specify both simultaneously. This situation can be handled in a number of ways. One way is to choose the input dummy bit to assign the first output processed bit in the normal way, then subsequently reverse the understanding of 0's and 1's. This takes care of the second bit; note that the receiver can reverse-engineer all these steps and recover the intended bits.

In view of the above, it can be seen the present invention presents a significant advancement in the art of “bit loading” techniques associated with wireless local area networks (WLANs). Further, this invention has been described in considerable detail in order to provide those skilled in the WLAN art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. A method of bit loading in a multi-tone wireless local area network (LAN), the method comprising the steps of:
identifying the weakest data tone associated with a desired standards-compliant air interface for a multi-tone wireless LAN;
determining if any data bit(s) associated with the requisite communication protocol will be inserted into a weak tone subsequent to processing; and
selectively inserting a dummy bit to corrupt the input data stream if a data bit will be inserted into a weak tone subsequent to processing, such that the respective processed bit associated with the selectively inserted dummy bit will be a zero.

2. The method according to claim 1 further comprising the step of modifying desired header bits associated with the processed data stream such that a receiver will be aware that the transmission has been modified, and is aware of where the modified bits occur.

3. The method according to claim 2 further comprising the step of reversing the dummy bit stuffing process to identify the dummy bits added to the transmitted stream and recover the original data bits therefrom.

4. The method according to claim 1 further comprising the step of modifying a CRC checksum by masking with a predetermined known non-zero pattern, such that only an intended recipient selected from among a plurality of wireless LAN users will recognize the modified transmission.

5. The method according to claim 1 wherein the step of selectively inserting a dummy bit to corrupt the input data stream if a data bit will be inserted into a weak tone subsequent to processing, such that the respective processed bit associated with the selectively inserted dummy bit will be a zero comprises inserting a dummy bit whenever a data bit will be inserted into a weak tone subsequent to processing such that zero bits of information are transmitted on the weak tone.
